(19) United States
(12) Patent Application Publication
(10) Pub. No.: US 2008/0004790 A1
(43) Pub. Date: Jan. 3, 2008

(54) Methods and system for providing routing assistance to a vehicle

(75) Inventor: Michael B. Ames, Lake Orion, MI (US)

Correspondence Address: GENERAL MOTORS CORPORATION;LEGAL STAFF, MAIL CODE 482-C23-B21, P O BOX 300, DETROIT, MI, 48265-3000, US

(73) Assignee: General Motors Corporation

(21) Appl. No.: 11/478,866

(22) Filed: Jun. 30, 2006

(51) Int. Cl. G08G 1/00; G01C 21/00

(52) U.S. Cl. 701/117; 701/200

(57) ABSTRACT

A method for providing routing assistance to a vehicle in an emergency situation includes establishing communication between a telematics unit in the vehicle and a service provider, determining the position of the vehicle, and identifying the location of the incident. The method further includes identifying an evacuation route toward a destination location, where the evacuation route is adapted to substantially avoid the incident. The evacuation route is transmitted to the telematics unit.

### TECHNICAL FIELD

The present disclosure relates generally to vehicles, and more particularly to method(s) and system(s) for providing routing assistance to a vehicle.

### BACKGROUND

Several states, counties, and cities have identified evacuation routes for vehicles in the event of an emergency, such as, for example, a natural or human-caused disaster. Current methods of informing people of such emergency evacuation routes include road signs, radio media, television media, and/or printed media.

Many people (particularly travelers and those unfamiliar with an area's roads, evacuation routes, and shelters) often encounter difficulty in discovering and following emergency evacuation directions. Additionally, standard evacuation routes that are prepared prior to the onset of an emergency generally do not take into account the specific features and/or nature of the particular incident.

While many evacuation routes are declared at the time of evacuation, many destination locations, such as shelters, are identified in advance. For example, shelters that are outside the projected path of a hurricane or tornado may be identified in advance. Again, such standard shelter locations may not take into account the specific features and/or nature of the particular incident. When unpredictable (e.g., tornados with an unforeseeable path and/or duration) or unexpected (e.g., earthquakes or explosions) natural or unnatural events occur, shelters may be identified dynamically. Such shelter identifications generally take into account the specific features of the incident. However, this may not be of assistance to those unfamiliar with the area or the particular shelter location.

### SUMMARY

A method for providing routing assistance to a vehicle in an emergency situation includes establishing communication between a telematics unit in the vehicle and a service provider, determining the position of the vehicle, and identifying the location of the incident. The method further includes identifying an evacuation route toward a destination location, where the evacuation route is adapted to substantially avoid the incident. The evacuation route is transmitted to the telematics unit.

### BRIEF DESCRIPTION OF THE DRAWINGS

Objects, features and advantages of embodiments of the present disclosure may become apparent by reference to the following detailed description and drawings, in which:

FIG. 1 is a schematic diagram depicting an embodiment of a system for providing routing assistance to a vehicle in an emergency situation;

FIG. 2 is a flow diagram depicting an embodiment of a method for providing routing assistance to a vehicle in an emergency situation; and

FIG. 3 is a flow diagram depicting another embodiment of a method for providing routing assistance to a vehicle in an emergency situation.

### DETAILED DESCRIPTION OF THE EMBODIMENTS

Embodiment(s) of the system and method disclosed herein advantageously provide for improved transmission of evacuation routes to a vehicle in an emergency situation/incident. Vehicle position data may be utilized in conjunction with incident location data to determine an evacuation route to a destination location, such as a shelter and/or any other designated area, city, state, or the like, as desired. Embodiment(s) of the method(s) and system(s) may also advantageously transmit an emergency egress route over a broadcast system, whereby the transmission may be received by an in-vehicle telematics unit.

It is to be understood that, as defined herein, a user may include vehicle operators and/or passengers.

It is to be further understood that the emergency situation or incident may include any of a multitude of natural or unnatural (e.g., human- or animal-caused) emergency situations. As non-limitative examples, the incident may include a hurricane, a tornado, a monsoon, a typhoon, a cyclone, a tsunami, a tidal wave, a volcanic eruption, a landslide, an avalanche, a flood, an earthquake, a fire, an explosion, riots, incidents relating to war and/or terrorism, or combinations thereof.

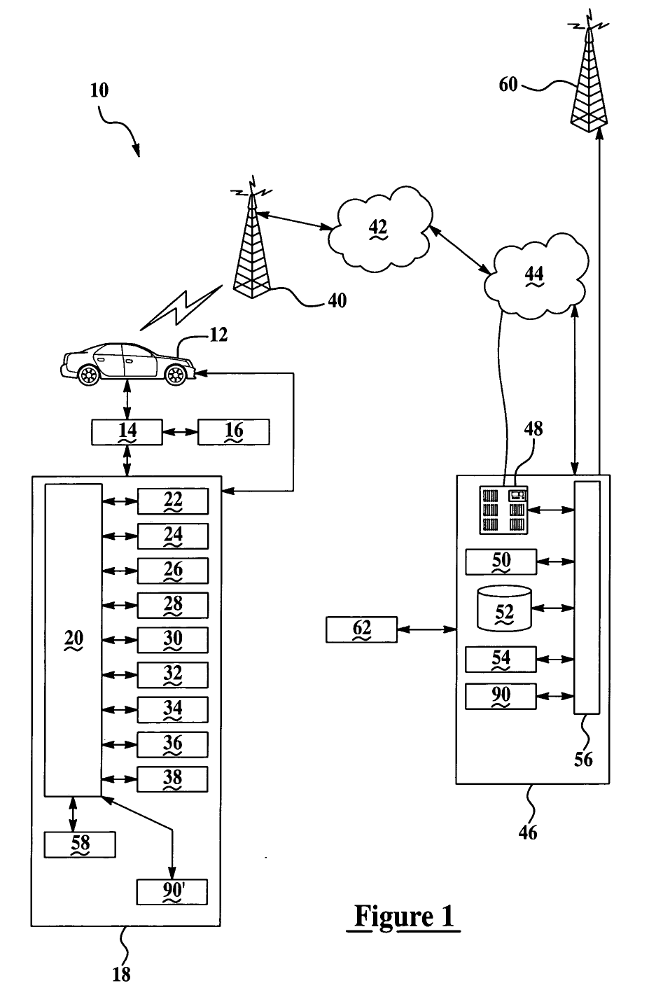

Referring now to FIG. 1, the system 10 includes a vehicle 12, a vehicle communications network 14, a telematics unit 18, a wireless communication system (including, but not limited to, one or more wireless carrier systems 40, one or more communication networks 42, and/or one or more land networks 44). In an embodiment, the wireless communication system is a two-way radio frequency communication system. In another embodiment, the wireless communication system also includes one or more call centers/service providers 46 and/or one or more broadcast systems 60. In yet another embodiment, vehicle 12 is a mobile vehicle with suitable hardware and software for transmitting and receiving voice and data communications. System 10 may include additional components suitable for use in telematics units 18.

In an embodiment, via vehicle communications network 14, the vehicle 12 sends signals from the telematics unit 18 to various units of equipment and systems 16 within the vehicle 12 to perform various functions, such as unlocking a door, executing personal comfort settings, and/or the like. In facilitating interaction among the various communications and electronic modules, vehicle communications network 14 utilizes interfaces such as controller area network (CAN), ISO standard 11989 for high speed applications, ISO standard 11519 for lower speed applications, and Society of Automotive Engineers (SAE) standard J1850 for high speed and lower speed applications.

The telematics unit 18 may send and receive radio transmissions from wireless carrier system 40. In an embodiment, wireless carrier system 40 may be a cellular telephone system and/or any other suitable system for transmitting signals between the vehicle 12 and communications network 42. Further, the wireless carrier system 40 may include a cellular communication transceiver, a satellite communications transceiver, a wireless computer network transceiver (a non-limitative example of which includes a Wide Area Network (WAN) transceiver), and/or combinations thereof.

Telematics unit 18 may include a processor 20 operatively coupled to a wireless modem 22, a location detection system 24 (a non-limitative example of which is a global positioning system (GPS)), an in-vehicle memory 26, a microphone 28, one or more speakers 30, an embedded or in-vehicle mobile phone 32, and/or a short-range wireless communication network 38 (e.g. a Bluetooth® unit).

It is to be understood that the telematics unit 18 may be implemented without one or more of the above listed components, such as, for example, speakers 30. Yet further, it is to be understood that the speaker(s) 30 may be a component of the vehicle audio system (which includes a receiver), which may, in addition to radio broadcasts, accept audio and other signals from the telematics unit 18. Telematics unit 18 may include additional components and functionality as desired for a particular end use.

Processor 20 may be a micro controller, a controller, a microprocessor, a host processor, and/or a vehicle communications processor. In another embodiment, processor 20 may be an application specific integrated circuit (ASIC). Alternatively, processor 20 may be a processor working in conjunction with a central processing unit (CPU) performing the function of a general-purpose processor.

Non-limitative examples of the location detection system 24 include a Global Position Satellite receiver, a radio triangulation system, a dead reckoning position system, and/or combinations thereof. In particular, a GPS provide accurate time and latitude and longitude coordinates of the vehicle 12 responsive to a GPS broadcast signal received from a GPS satellite constellation (not shown). In-vehicle mobile phone 32 may be a cellular type phone, such as, for example an analog, digital, dual-mode, dual-band, multi-mode and/or multi-band cellular phone.

Associated with processor 20 is a real time clock (RTC) 34 providing accurate date and time information to the telematics unit hardware and software components that may require date and time information. In one embodiment, date and time information may be requested from the RTC 34 by other telematics unit components. In other embodiments, the RTC 34 may provide date and time information periodically, such as, for example, every ten milliseconds.

Processor 20 may execute various computer programs that interact with operational modes of electronic and mechanical systems within the vehicle 12. It is to be understood that processor 20 controls communication (e.g. signals such as call signals) between telematics unit 18, wireless carrier system 40, and call center 46.

Further, processor 20 may generate and accept digital signals transmitted between the telematics unit 18 and the vehicle communication network 14, which is connected to various electronic modules in the vehicle 12. In one embodiment, these digital signals activate the programming mode and operation modes within the electronic modules, as well as provide for data transfer between the electronic modules. In another embodiment, certain signals from processor 20 may be translated into vibrations and/or visual alarms.

It is to be understood that software 58 may be associated with processor 20 for monitoring and/or recording the incoming caller utterances.

The communications network 42 may include services from one or more mobile telephone switching offices and/or wireless networks. Communications network 42 connects wireless carrier system 40 to land network 44. Communications network 42 may be any suitable system or collection of systems for connecting the wireless carrier system 40 to the vehicle 12 and the land network 44.

The land network 44 connects the communications network 40 to the call center/service provider 46. In one embodiment, land network 44 is a public switched telephone network (PSTN). In another embodiment, land network 44 is an Internet Protocol (IP) network. In still other embodiments, land network 44 is a wired network, an optical network, a fiber network, another wireless network, and/or any combinations thereof. The land network 44 may be connected to one or more landline telephones. It is to be understood that the communications network 42 and the land network 44 connect the wireless carrier system 40 to the call center 46.

Call center 46 contains one or more data switches 48, one or more communication services managers 50, one or more communication services databases 52 containing subscriber profile records and/or subscriber information, one or more communication services advisors 54, and one or more network systems 56.

Switch 48 of call center 46 connects to land network 44. Switch 48 transmits voice or data transmissions from call center 46, and receives voice or data transmissions from telematics unit 18 in vehicle 12 through wireless carrier system 40, communications network 42, and land network 44. Switch 48 receives data transmissions from, or sends data transmissions to one or more communication service managers 50 via one or more network systems 56.

Call center 46 may contain one or more service advisors 54. In one embodiment, service advisor 54 may be human. In another embodiment, service advisor 54 may be an automaton.

Call center 46 may be in communication with one or more broadcast system(s) 60. Broadcast system 60 may include any suitable means for transmitting information and/or signals in a broadcast manner. The term “broadcast”, as used herein, refers to a simultaneous transmission to one or more receivers in a defined area. As a non-limitative example, the broadcast system 60 may include one or more radio/satellite radio channels that are transmitting a signal to vehicle(s) 12 that are located in an area proximate to the incident (described further hereinbelow). These channels may, if desired, be identified by the call center 46 by method(s)/combinations of methods described below. The call center 46 may then pre-empt the channel signal transmission in order to broadcast egress routes, general destination locations, and/or combinations thereof to numerous vehicles within the area proximate the incident.

A list of traffic and/or data channels assigned to specific regions may be provided to the call center 46 by the satellite radio system. Satellite radio systems broadcast traffic incident data on data channels. These channels broadcast traffic conditions and incidents' for regions/cities throughout the country, and have street level granularity. A traffic/data channel may be shared or “time sliced.” For example, traffic data may be broadcast for the Chicago area, then switched to the Detroit area, then back to Chicago, and so on. Generally, traffic/data channels are individually assigned to specific regions or cities, such as Channel 121 for Chicago, Channel 122 for Detroit, Channel 123 for Boston, etc. Traffic channels may be utilized for egress routes, or reserve data channels may be utilized.

In an embodiment, sets of latitude and longitude coordinates that bound the incident area may precede the egress routes. The call center 46 may provide the bounding coordinates and egress routes from data received from external sources. The call center 46, in communication with a satellite uplink system (i.e. broadcast system 60) may provide the bounding coordinates and egress routes, and may also select a traffic channel or available data channel. The broadcast system 60 broadcasts the bounding coordinates and egress routes. Vehicles receive the broadcasts and determine whether they are in the affected area by accessing current vehicle position made available by the GPS receiver in the telematics unit 18. The telematics unit 18 can determine if the current position is within the bounding coordinates. If the current position is within the bounding coordinates, the egress data is accepted and presented; if not, the egress data is rejected.

In another example, the egress routes may be broadcast without bounding information, and the vehicle occupants may determine whether the egress routes are relevant or not. In yet a further example, the call center 46 need not have any knowledge of the channels. The call center 46 may send the egress data to the satellite uplink facility 60, and the uplink facility 60 may select the channel(s).

Still further, the call center 46 may be in communication with a third-party provider 62 that provides egress routes and general destination locations for vehicles 12 within the area proximate the incident. Non-limiting examples of such third-party providers 62 include news feeds, federal agencies, state agencies, local agencies (e.g., city police departments, etc.), or combinations thereof.

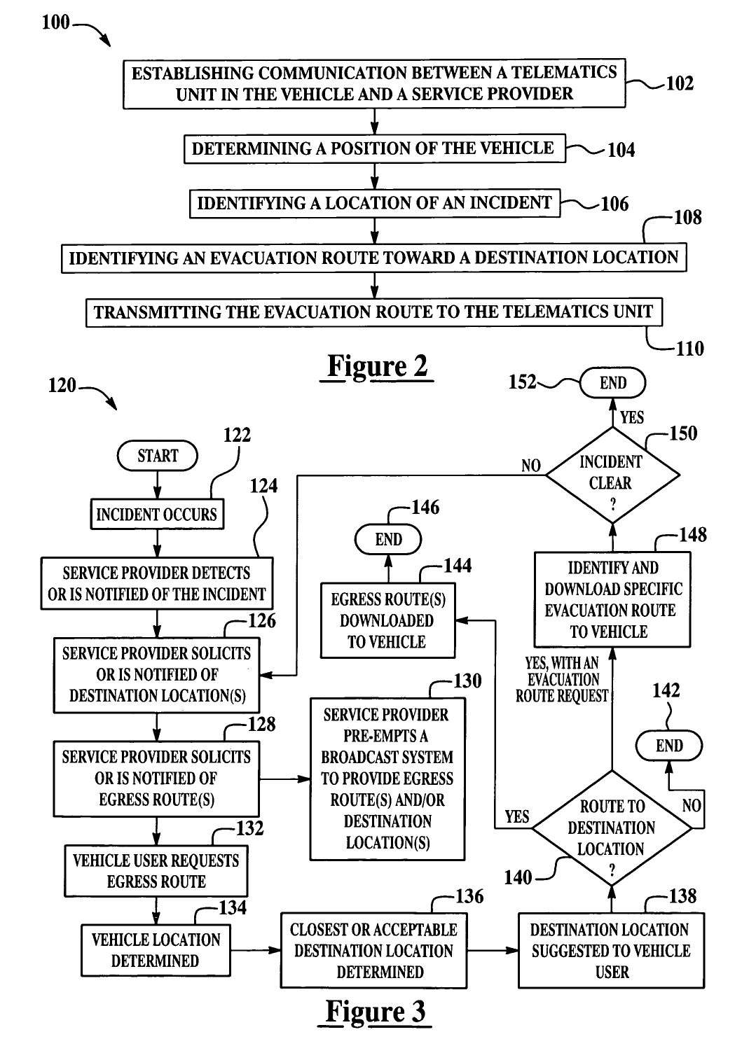

Referring now to FIG. 2, an embodiment of a method 100 for providing routing assistance to a vehicle 12 in an emergency situation includes establishing communication between a telematics unit 18 in the vehicle 12 and a service provider 46, as depicted at reference numeral 102; determining a position of the vehicle 12, as depicted at reference numeral 104; and identifying a location of an incident, as depicted at reference numeral 106. The method 100 also includes identifying an evacuation route toward a destination location, where the evacuation route is adapted to substantially avoid the incident, as depicted at reference numeral 108; and transmitting the evacuation route to the telematics unit 18, as depicted at reference numeral 110.

Establishing communication between the telematics unit 18 and the service provider 46 may be accomplished via the wireless communication system. In an embodiment, the service provider 46 becomes aware of the emergency situation, may locate (for example, via method(s)/combinations of methods described below) one or more subscriber vehicles 12 within an area proximate the emergency situation, and may initiate communication with those vehicle(s) 12 in order to determine if the vehicle 12 is in need of an evacuation route, a location destination, egress route (described further in reference to FIG. 3), and/or a general location destination (described further in reference to FIG. 3). In another embodiment, the vehicle user may be aware of the emergency situation and may request an evacuation route from the service provider 46.

The service provider/call center 46 may approximate whether a subscriber's vehicle 12 is in an incident area by the vehicle's “garage address,” which is the residential address of the subscriber. For example, if a subscriber lived in New Orleans during Hurricane Katrina, then the confidence level is high that the subscriber is in the incident area.

In another example, each vehicle 12 in the incident area known by its garage address may be contacted by the call center 46 to determine the vehicle's actual current position. One method of accomplishing this is as follows. Each vehicle identification number (VIN) is known for each subscriber. The VIN may be used to send egress routes to individual vehicles 12. The telematics unit 18 is aware of the VIN of the vehicle 12 in which the unit 18 is installed, and may compare the incoming VIN (from the call center 46) to its own. If the VINs match, then the egress route is accepted.

In yet a further example, the egress information may be broadcast, and the satellite radio receiver “listens” in the background in a dual receiver system (required for XM traffic data) that filters the egress data by city or region code. An algorithm may be present in the telematics unit 18 that can calculate a city or region code via the vehicle's current position. In a case where the vehicle does not have a GPS receiver, if the terrestrial repeater (i.e. ground stations that pick up and locally broadcast satellite radio content) broadcasts its ID or location code, that could be used to roughly determine the position of the vehicle.

It is to be understood that the phrase “area proximate to the incident” or “area proximate to the emergency situation” as used herein, refers to the general area surrounding the incident/emergency situation that is affected by, or that may be affected by the incident/emergency situation. For example, the area proximate to a hurricane may include those areas that experience the actual hurricane, high winds, and/or heavy rains. It is to be understood that the area proximate to the incident may change if the incident changes course/direction or is controlled (e.g., a fire).

In the embodiment in which the service provider 46 initiates communication with the vehicle 12, the service provider 46 initially becomes aware of the emergency situation or incident. The service provider 46 may learn, among other things, the location of the incident, the type of incident, the projected path of the incident, or the like, or combinations thereof. It is to be understood that such information may be communicated to the service provider 46 via the third-party provider 62 (non-limitative examples of which includes one or more incoming news feeds (e.g., an API press feed, CNN®, The Weather Channel®, etc.), governmental agencies, or the like, or combinations thereof).

Upon becoming aware of the incident, the service provider 46 may locate (for example, by method(s) or combinations of methods described above) one or more subscriber vehicles 12 that are then-currently located within a predetermined area surrounding the incident. The predetermined area may depend, at least in part, on the type of incident, the projected path of the incident, the speed at which the incident may move or spread, or the like, or combinations thereof.

The service provider 46 then initiates communication with the vehicle 12 by calling the vehicle 12 via the wireless communication system.

In the embodiment in which the vehicle user requests an evacuation route, the method includes initiating an evacuation route request via the telematics unit 18, and transmitting the evacuation route request from the telematics unit 18 to the service provider. The user may initiate the evacuation route request via verbal communication, physical communication, and/or combinations thereof. The operator/user may initiate the request via an input system in communication with the wireless communication system, which transmits the request to the service provider 46. As non-limitative examples, the input system may include an alphanumeric keypad, a microphone 28, a menu selection system, and/or combinations thereof, each of which is in communication with the telematics unit 18.

Physically initiating the request may be accomplished via a button press, touch screen, or the like located in the vehicle 12. It is to be understood that the button press or touch screen is operatively connected to the telematics unit 18. Upon the user's initiation of the button press or touch screen, the telematics unit 18 signals the call center 46 of the fact that the user has initiated a request.

Verbally initiating the request may take place via microphone 28 coupled to the in-vehicle or mobile phone 32 associated with the telematics unit 18. Caller utterances into the microphone 28 are received at a call center 46, which tokenizes the utterance stream for further processing. In one embodiment, the tokenized utterances are placed in a subscriber information database 52 at the call center 46.

Upon initiation of communication between the call center 46 and the vehicle user, the user may inform the call center 46 of his/her current position, or alternately, the vehicle's current position may be transmitted to the call center 46 from the location detection system 24 (e.g., GPS unit) via the telematics unit 18. Prior to initiating communication, the call center 46 may have already approximated the vehicle's 12 position, for example, via the subscriber's garage address. In this embodiment, the call center 46 may update the position of the vehicle 12 upon establishing communication.

Once the service provider/call center 46 is aware of the incident and the vehicle's position, the service provider/call center 46 may identify an evacuation route toward a destination location. It is to be understood that the “evacuation route” may be a general egress route that is suitable for the evacuation of numerous vehicles 12 in the area proximate the incident, and/or it may be a more specific route including navigational instructions for the vehicle 12, based, at least in part, on the location of the vehicle 12. The general egress route may be open-ended (i.e., with no specific destination, for example, head north on Highway X), or it may direct numerous vehicles to a particular location (e.g., head north on Highway X toward a designated shelter X).

In an embodiment, identifying the evacuation route includes the service provider 46 receiving (e.g., via wireless and/or landline telephones, Internet connections, radio feeds, etc.) general egress route(s) and/or locations of designated shelter(s) from the third-party provider(s) 62. The service provider 46 may then transmit (via the wireless communication network) the general egress route(s) and/or the location(s) of the designated shelter(s) to the telematics unit 18 as the evacuation route and the destination location(s). It is to be understood that numerous egress routes may be transmitted from the third-party provider 62 ultimately to the vehicle user, who may choose which the of egress routes to pursue.

Alternately or in addition to identifying and/or transmitting the egress route and/or shelter destinations, the service provider 46 may identify a specific evacuation route for the vehicle 12. In an embodiment, the specific evacuation route is generated at the call center 46 via a route generator 90. It is to be understood that the route generator 90 may include an electronic system (e.g., a server based navigation system) or may be a human-driven system.

Generally, the specific evacuation route includes navigational instructions directing the vehicle 12 toward a destination location, such as an emergency shelter. The navigational instructions may be generated in the form of textual instruction and/or audio prompts (described further hereinbelow).

The specific route may also be selected from a database (e.g., one of the communication services databases 52) of previously stored evacuation routes. The previously stored evacuation routes may also include a final destination (e.g., a shelter). Generally, the previously stored evacuation routes have been generated for projected or likely emergencies/incidents, or have been generated for previous emergencies/incidents in a particular area. The service provider 46 may maintain these routes for extended periods, particular for those situations that have substantially predictable routing (e.g., areas that have flooded on numerous occasions). Furthermore, the previously stored routes may be frequently updated. In an embodiment, the service advisors 54 at the call center 46 may access the database and run a query for stored evacuation routes in the area of the incident. The database may produce any number of previously stored routes, and the service advisor 54 selects the most suitable route for the vehicle 12. If the database does not produce any previously stored routes, the call center 46 may generate a new evacuation route for the vehicle 12. It is to be understood that such a route may be added to the database.

In still another embodiment, the service provider 46 may download a list of the egress route(s) and/or destination location(s) (e.g., those provided to the service provider 46 from the third-party provider 62) to the vehicle telematics unit 18. The telematics unit 18 may be equipped with an on-board electronic route generator 90′ (shown in FIG. 1) that processes the received information. The on-board route generator 90′ may then generate a specific evacuation route for the vehicle 12, taking into account the position of the vehicle 12 (supplied to the route generator 90′ by the location detection system 24), and the suggested egress route(s)/destination location(s) provided by the service provider 46. As such, it is to be understood that the evacuation route supplied by the on-board route generator 90′ may be generated in addition to the egress route that is initially supplied by a third-party provider 62.

In any of the embodiments disclosed herein, identifying the specific evacuation route may be based, at least in part, on the position of the vehicle 12, the general egress route(s), and/or a desirable destination location (e.g., a shelter closest to the then-current position of the vehicle 12). In an embodiment, identifying the specific evacuation route(s) includes consideration of one or more factors. Non-limitative examples of such factors include the proximity between the incident location and the vehicle position; the potential proximity between an effect of the incident and the evacuation route; current and/or projected traffic conditions along the evacuation route; construction along the evacuation route; current and/or projected weather conditions along the evacuation route; distance to the destination location; estimated time of travel to the destination location; and/or combinations thereof. It is to be understood that the call center 46 may be in communication with the Internet and/or various third-party providers 62 (e.g., traffic centers, weather centers, etc.) which may feed at least some of the information to the call center 46.

In a non-limiting example embodiment, the route generator 90 or service advisor 42 at the call center 46 may recognize that the most direct evacuation route to the destination location is in the projected path of the incident (e.g., a tornado); and, as such, may generate an alternate evacuation route, or may direct that an alternate evacuation route be generated that substantially avoids the incident or effects of the incident (e.g., fallen trees/buildings/telephone lines, flooded areas, or the like, or combinations thereof).

As previously stated, it is to be further understood that identifying the specific evacuation route may also include identifying one or more destination locations (e.g., shelters). As non-limitative examples, a destination location may be identified by the service provider 46, or may be provided to the service provider 46 by a third-party provider 62, a vehicle user (e.g., if the user is aware of the closest shelter), or any other suitable source. In an embodiment where many destination locations are identified, the evacuation route may be configured to direct the user to the destination location closest to and/or most accessible for the vehicle 12. A destination location that is most accessible for the vehicle 12 may not necessarily be the closest destination location. For example, the closest destination location to the vehicle 12 may, for example, have its access blocked as a result of the incident, have been destroyed as a result of the incident, have reached maximum capacity, or the like. As a result, the evacuation route may be configured to avoid that particular destination location.

After the service provider 46 identifies the egress route, the specific evacuation route, or the destination location(s), it may transmit such information to the telematics unit 18 via the wireless communication system. The telematics unit 18 then transmits the information to a notification system 36. The notification system 36 may display the route as one or more audio prompts and/or textual instructions. In an embodiment, the notification system 36 includes the vehicle's audio system and/or an electronic display system. As a non-limitative example, the route and/or location navigational information may be transmitted as audio prompts from the telematics unit 18 to vehicle speakers 30. As another non-limitative example, the route and/or location navigational information may be transmitted as textual instructions from the telematics unit 18 to a vehicle radio display.

In an embodiment in which an on-board route generator 90′ generates the specific evacuation route, it transmits (via audio prompts and/or textual instructions) such information to the notification system 36 via the telematics unit 18.

In a further embodiment, the egress route, evacuation route, and/or location destination is/are transmitted to the telematics unit 18 in real-time. For example, the navigational commands are provided to the user as necessary to navigate the route. In another embodiment, the egress route, evacuation route, and/or location destination is transmitted to the telematics unit 18 in its entirety, and the telematics unit 18 (e.g., via the notification system 36) either provides the navigational commands in real-time, or provides the information in its entirety. As non-limitative examples, providing the route in real-time may be preferable for a route delivered audibly, and providing the route in its entirety may be preferable for a route delivered textually and/or graphically.

In another embodiment of the method, a general egress route, directions toward a general destination location, and/or notification of the position of a destination location may be provided over a broadcast system 60. As previously described, the broadcast system 60 may include one or more radio/satellite radio channels that are transmitting signal(s) to vehicle(s) 12 that are located in an area proximate to the incident. These channels may be identified by the call center 46 (e.g., via a list provided to it (from the satellite radio service provider) of active and/or available traffic and/or data channels), which pre-empts the channel signal transmission in order to broadcast egress routes, general destination locations, and/or combinations thereof to numerous vehicles 12 within the area proximate to the incident. Pre-emption may occur by the call center 46 requesting channel access, and the satellite radio provider at the uplink facility 60 making the channel(s) available to the call center 46. Egress routes may be properly formatted and provided as a data feed from the call center 46 to the uplink facility 60.

As non-limitative examples, the egress route may be broadcast via audible or visual cues to vehicles 12 in an area affected by an emergency situation. The egress route (e.g., supplied to the call center 46 via the third-party provider 62) may, for example, direct users toward an emergency shelter along one or more routes identified and configured to avoid the incident. In another embodiment, the egress route may be an open-ended route configured to avoid the incident, but having no fixed destination.

In any of the embodiments disclosed herein, it is to be understood that the evacuation route may be updated at any time. In an embodiment, the destination location (and, thus, the route) may be updated during transmission of the initial route, if, for example, that route suddenly becomes inaccessible or undesirable for travel.

Referring now to FIG. 3, another embodiment of a method 120 for providing routing assistance to a vehicle 12 in an emergency situation is depicted. The method starts at reference numeral 122 where an incident (e.g., avalanche, flood, etc., as previously described) occurs. The service provider/call center 46 detects or is notified of the incident (e.g., the type of incident, its location, its size, its speed or movement, etc.) as shown at reference numeral 124. It is to be understood that detection may be accomplished via monitoring news feed(s) and/or an Internet source, and notification may be accomplished via a third-party provider 62 (as previously described).

The method further includes the service provider 46 identifying (i.e., soliciting or being notified of) one or more general destination locations, as depicted at reference numeral 126, and identifying one or more general egress routes toward the destination location, as depicted at reference numeral 128. As previously described, these general routes and destination locations may be provided to the service provider/call center 46 via the third-party provider 62 (e.g., the federal, state, or local governments, the national weather service, etc.).

Upon identifying the incident, the destination locations, and the egress routes, the service provider 46 may 1) identify a broadcast channel that is transmitting signal(s) to vehicles 12 within an area proximate to the incident, and 2) pre-empt the broadcast channel to transmit/broadcast the egress route(s) and/or destination location(s) to such vehicles 12, as shown at reference numeral 130.

Alternately, or in addition to the broadcast, the service provider 46 may receive a request for an evacuation route from a vehicle user, who is transmitting the request verbally or physically using components of the telematics unit 18 in the vehicle 12, as depicted at reference numeral 132. Upon receiving the request, the service provider 46 obtains (e.g., via the vehicle's location detection system 24) the position of the vehicle 12, as depicted at reference numeral 134; and identifies a destination location (e.g., a shelter) tailored to (i.e., accessible from and/or closest to) the position of the vehicle 12, as depicted at reference numeral 136.

In this embodiment, the identified destination location is transmitted from the service provider 46 to the vehicle user via the wireless communication system, as shown at reference numeral 138.

The service provider 46 may then inquire as to whether the vehicle user desires a route to the identified destination location. Alternately, the user may inquire as to whether the service provider 46 is able to provide a route to the identified destination. These inquiries are shown at reference numeral 140.

In one embodiment, if the vehicle user does not request, or declines, the route information, the method is complete, as shown at reference numeral 142. In another embodiment, if the user wants the route, the service provider 46 transmits (via the wireless communication system) the previously identified egress route(s) to the telematics unit 18 (which then transmits the information to the user via the notification system 36), as shown at reference numeral 144, and the method is complete, as shown at reference numeral 146. In still another embodiment, if the user requests a specific evacuation route beyond the general egress route, the service provider 46 may identify/generate and download the navigational instructions of the specific evacuation route towards a specific destination location (as described hereinabove) to the vehicle 12, as shown at reference numeral 148.

In this, or any of the embodiments disclosed herein, the service provider 46 may, if desired, check with the vehicle 12 to ensure that the vehicle 12 has arrived at the destination location or has traveled outside the area proximate to the incident, as shown at reference numeral 150. If the vehicle 12 is clear of the incident, the method is complete, as shown at reference numeral 152. If the vehicle 12 is not yet clear of the incident, the service provider may re-check the general destination locations (reference numeral 126) and egress routes (reference numeral 128) to ascertain if the vehicle 12 is still traveling on a desirable evacuation route. If the current route is no longer desirable, the service provider may generate and transmit another evacuation route to the vehicle 12. It is to be understood that this may continue until the vehicle 12 is clear of the incident.

Regarding all of the embodiments disclosed herein, it is to be understood that the third-party provider 62 may supply the service provider 46 with the general destination location(s) and the general egress route(s). More specific evacuation routes and/or locations may be generated and transmitted to the vehicle 12. However, in some embodiments, the general egress routes and destination locations may be substantially the same as the more specific evacuation route and/or destination location. This may occur, for example, when the vehicle 12 is in a position closest to the egress route or the general destination location, when access to other roads is limited, when destination locations (e.g., shelters) become inaccessible or reach maximum capacity, or the like, or combinations thereof.

While several embodiments have been described in detail, it will be apparent to those skilled in the art that the disclosed embodiments may be modified. Therefore, the foregoing description is to be considered exemplary rather than limiting.

1. A method for providing routing assistance to a vehicle in an emergency situation, comprising:
establishing communication between a telematics unit in the vehicle and a service provider;
determining a position of the vehicle;
identifying a location of an incident;
identifying an evacuation route toward a destination location, the evacuation route adapted to substantially avoid the incident; and
transmitting the evacuation route to the telematics unit.

2. The method of claim 1 wherein identifying the evacuation route includes consideration of at least one factor selected from: proximity between the incident location and the vehicle position; potential proximity between an effect of the incident and the evacuation route; traffic along the evacuation route; construction along the evacuation route; weather conditions along the evacuation route; distance to the destination location; estimated time of travel to the destination location; and combinations thereof.

3. The method of claim 1 wherein identifying the evacuation route includes identifying a plurality of potential evacuation routes and selecting a preferred evacuation route from the plurality of potential evacuation routes.

4. The method of claim 3 wherein the plurality of potential evacuation routes is stored in a database of predetermined routes.

5. The method of claim 1 wherein identifying the evacuation route includes receiving, at the service provider, a general egress route from a third-party provider.

6. The method of claim 5, further comprising generating, via a server-based navigation system at the service provider, an other evacuation route toward the destination location.

7. The method of claim 5, further comprising:
downloading the general egress route from the service provider to the telematics unit; and
generating, via a route generation engine located in the telematics unit, an other evacuation route based on the general egress route.

8. The method of claim 1 wherein, prior to determining the position of the vehicle, the method further comprises:
initiating, via at least one of verbal communications or physical communications, an evacuation route request from a vehicle user via the telematics unit; and
transmitting the evacuation route request from the telematics unit to the service provider.

9. The method of claim 1 wherein establishing communication is accomplished via a two-way communication system.

10. The method of claim 1 wherein the incident includes a hurricane, a tornado, a monsoon, a typhoon, a cyclone, a tsunami, a tidal wave, a volcanic eruption, a landslide, an avalanche, a flood, a fire, an earthquake, a human-caused incident, an animal-caused incident, or combinations thereof.

11. The method of claim 1 wherein the destination location includes an emergency shelter.

12. The method of claim 1, further comprising transmitting the evacuation route from the telematics unit to a notification system configured to deliver the evacuation route to a vehicle user via at least one of audio prompts, textual instructions, graphical instructions, or combinations thereof.

13. The method of claim 1 wherein the evacuation route is transmitted in real-time.

14. A method for providing routing assistance to a vehicle in an emergency situation, comprising:
identifying, at a service provider, a location of an incident;
identifying, at the service provider, a general destination location;
identifying, at the service provider, an egress route toward the general destination location, the egress route adapted to substantially avoid the incident;
establishing communication between a telematics unit in the vehicle and the service provider;
determining a position of the vehicle;
identifying a destination location tailored to the position of the vehicle;
identifying an evacuation route toward the destination location, the evacuation route adapted to substantially avoid the incident; and
transmitting the evacuation route to the telematics unit.

15. The method of claim 14 wherein a third-party provider identifies at least one of the general destination location or the egress route.

16. The method of claim 14 wherein the general destination location is substantially the same as the destination location.

17. The method of claim 14 wherein the egress route is substantially the same as the evacuation route.

18. The method of claim 14 wherein the evacuation route is transmitted in real-time.

19. The method of claim 14, further comprising:
identifying at least one satellite radio channel that is transmitting a signal to a plurality of vehicles located within an area proximate to the incident; and
pre-empting the signal transmission from the at least one satellite radio channel to broadcast at least one of the egress route, the general destination location, or combinations thereof to the plurality of vehicles.

20. A system for providing routing assistance to a vehicle in an emergency situation, comprising:
an in-vehicle telematics unit;
a location detection system in communication with the in-vehicle telematics unit, the location detection system configured to determine a position of the vehicle;
a two-way radio-frequency communication system in communication with the telematics unit, whereby the telematics unit communicates with a service provider; and
a notification system in communication with the telematics unit, the notification system configured to deliver an evacuation route, received by the telematics unit from the service provider, to a vehicle user via at least one of audio prompts, textual instructions, or combinations thereof;
wherein the evacuation route is transmitted in response to identifying an incident and the vehicle's position relative to the incident.
